(19) United States
(12) Patent Application Publication
(10) Pub. No.: US 2020/0088306 A1
(43) Pub. Date: Mar. 19, 2020

(54) EROSION RESISTANT CHOKE VALVE

(71) Applicant: Lancaster Flow Automation, LLC, Houston, TX (US)

(72) Inventors: Gerado Haro-Valdez, Houston, TX (US); Weston William Woods, Spring, TX (US)

(21) Appl. No.: 16/572,350

(22) Filed: Sep. 16, 2019

Related U.S. Application Data
(60) Provisional application No. 62/732,230, filed on Sep. 17, 2018.

(51) Int. Cl. F16K 3/20; F16K 47/10

(52) U.S. Cl. CPC F16K 3/20; F16K 47/10

(57) ABSTRACT

A valve apparatus for controlling the flow and pressure of fluids from a source of pressurized fluid with: a valve body, a valve chamber, a seat assembly in the valve chamber; a control member in the valve chamber axially movable with respect to the seat assembly, a lower stem connected to an output of an actuator of the valve, a valve bonnet attached to the valve body; the valve bonnet having a valve bonnet through bore with the lower stem slidingly reciprocating, moving the control member between the closed and open position, an annular sealing assembly, an outer seat carrier engaged within the valve body; the outer seat carrier comprising two elongated longitudinally disposed radial slots each oriented at right angles to the inlet port to impact a diversion wall of the outer seat carrier, splitting the inlet fluid into two flows simultaneously, reducing erosion on the radial slots.

### CROSS-REFERENCE TO RELATED APPLICATIONS

The application claims the benefit of U.S. Provisional Application Ser. No. 62/732,230, filed on Sep. 17, 2018, the entire contents of which are hereby incorporated by reference.

### FIELD

The present embodiment generally relates to a valve apparatus for controlling flow and pressure of fluids which are liquid, gas, or mixtures with or without particulate.

### BACKGROUND

A need exists for a more reliable choke valve.

The present embodiments meet these needs.

### BRIEF DESCRIPTION OF THE DRAWINGS

The detailed description will be better understood in conjunction with the accompanying drawings as follows:

FIG. 1 depicts a section view of a valve apparatus for controlling the flow and pressure of fluids from a source of pressurized fluid.

FIG. 2A-2B depict detailed section views of an outer seat carrier and inner seat insert.

FIG. 3 depicts a section view of an annular sealing assembly.

FIG. 4 depicts an embodiment of the anti-rotation assembly.

FIG. 5 depicts a cut view of the assembled valve connected to an actuator.

FIG. 6 depicts the flow path of fluid through the valve apparatus created by the outer seat carrier as mated to the inner seat insert.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

In the oil and gas industry, various types of valves or flow control devices are used both during drilling and production operations. One control device used in drilling is the “drilling choke”. The drilling choke is one of several well control devices used to control the fluid pressures and volumes encountered during drilling to prevent potential loss of control of the well.

Choke valves are also used in the production of oil and/or gas. These chokes are usually referred to as “production chokes”. The production choke may be used to throttle pressure and control the rate of production of petroleum fluids from a well. Production chokes may also be used to control and throttle the flow of fluids being injected into a well, such as is done in enhanced oil recovery operations.

In particular, the disclosed apparatus pertains to a valve apparatus commonly referred to as a “choke” for controlling the flow and pressure of fluids from or to an oil and/or gas well. More specifically, the disclosed apparatus pertains to a valve apparatus suitable for controlling the flow and pressure of fluids from a well during production.

The disclosed apparatus can also be used as a drilling choke which manages well bore pressure to maintain control in the event of a fluid or gas kick. Drilling chokes, like the one disclosed herein, work to prevent the loss of well control.

Because of the pressures, rate of flow and characteristics of petroleum fluids, most chokes encounter erosion and corrosion problems. Manufacturers have attempted to reduce these problems with numerous types of flow regulating or control elements which are placed in the choke or valve chamber to throttle and control fluids passing there through. If the flow regulating or control element is damaged and in need of repair or replacement, the valve may require time consuming and expensive repairs.

Another problem associated with production chokes is the inability to precisely determine the position of the flow control or regulating element of the valve and the flow area related thereto. Since the flow area changes with the position of the flow regulating element therein, such positions need to be accurately determined for precise flow control. Most mechanisms of the prior art for doing so involve relatively complex and expensive manufacturing processes which are not easily duplicated.

Another problem associated with production chokes is the force required for operation thereof. Due to the relatively high pressures associated therewith and the unbalanced forces due to such pressures, many production chokes require operating forces greater than desired, particularly for remote operation. Many of today's oil and/or gas wells are remotely operated by satellite or other means. The production chokes of such wells are preferably operated by low power DC electric motors. This is not possible with many production chokes of the prior art.

The valve apparatus disclosed herein is a production choke, primarily for the oil and/or gas industry, which provides a number of improved characteristics not found in the prior art. It provides a choke which is less susceptible to erosion and corrosion and easier to repair when so affected. It provides accurate position and flow area information for precise control of fluid flow therethrough, utilizing a unique position indicator in the yoke. In addition, it is extremely easy to operate, requiring less than eighteen (18) foot pounds of torque as compared to one hundred eighty (180) foot pounds for a typical prior art production choke operating at pressures of 10,000 psig.

Sand particles from oil and gas production may cause considerable erosion damage in critical parts of choke valves. Increased longevity of such components will lead to significant savings as offshore oil and gas production move subsea, and it can be achieved in two ways; through selection of erosion-resistant materials or through design optimization. Embodiments of the apparatus disclosed herein implement both a selection of erosion resistant materials and a unique design in the valve body containing a non-threaded seat carrier, that significantly slows the rate or erosion.

The choke valve disclosed herein has a valve body in which is a valve chamber with an inlet and an outlet. A valve seat is mounted in the valve chamber. A flow control member is also mounted in the valve chamber for axial movement with respect to the valve seat from a closed position, preventing the flow of fluids from the valve inlet to its outlet, and selected open positions which provide predetermined flow areas through which flow and pressure throttling of fluids may occur. A non-rotating stem assembly is attached to the control member for axial movement thereof. A valve bonnet is attached to the valve body and provided with a through bore in which the stem assembly may slidingly reciprocate while positioning the flow control member. A rotating driver assembly is supported from the valve bonnet and includes a nut member threadedly engageable with another end of the stem assembly. The nut translates rotational movement of the driver assembly to axial movement of the stem assembly and the flow control member attached thereto. An operating device is attached to the driver assembly for rotation thereof.

The non-threaded outer seat carrier design provides for fast and efficient repair of the valve. In previous designs, when a seat is threaded, once the threads are damaged due to erosion and/or corrosion, removal becomes much more difficult because the threads become deformed and galled to the choke body.

In a preferred embodiment of the disclosed apparatus the seat is provided in a unique cage member which cooperates with the flow control member attached to the stem assembly and provides predetermined flow areas in response to selected positions of the flow control member and stem assembly to which it is attached. The cage may include an inner cage of very hard erosion resistant material surrounded by an outer cage of less exotic materials. The stem assembly of the disclosed apparatus, which may include an upper stem and a lower stem, reciprocates within an annular seal assembly carried in the through bore of the valve bonnet. In a preferred embodiment, the lower stem is of two diameters leaving an annular space which, in cooperation with the annular seal assembly and a flow passage through the control member and stem, results in a semi-force balanced stem. The semi-force balanced stem and the driver assembly of the valve results in a valve with much reduced load and operating torque especially suitable for remote operation. The semi-force balanced stem and driver assembly make the disclosed choke valve extremely easy to operate, requiring less than eighteen (18) foot pounds of torque operating at 10,000 psig.

In a preferred embodiment of the disclosed apparatus, a unique indicating assembly is provided which includes a cylindrical drum attached to the driver assembly for rotation therewith. The outer surface of the drum has helically disposed indicia thereon which in combination with a pointer device attached to the anti-rotating stem assembly indicates a specific position of the flow control member and the predetermined flow area associated therewith.

The cylindrical drum, anti-rotation assembly, and the adjustable indicator pointer work together to provide accurate position and flow area information for precise control of fluid flow there through by providing predetermined flow areas based on selected positions of the flow control member.

Thus, the unique valve of the disclosed apparatus provides a production choke suitable for the oil and/or gas industry which provides accurate predetermined flow control with improved operating characteristics. It is especially suitable for accurate, remote control use. Many other objects and advantages of the disclosed apparatus will be apparent from reading the description which follows in conjunction with the accompanying drawings.

The disclosed apparatus prevents death by reducing the chances of the choke valve exploding due to degradation of the slots over time caused by particulate.

The disclosed apparatus reduces energy consumption by using less steel and extractive minerals, due to the longevity of the valve.

The disclosed apparatus prevents additional environmental problems by preventing the release of toxic hydrogen sulfide through ports in the valve body by providing a more reliable, longer lasting choke valve.

The disclosed apparatus prevents fire and explosions by preventing the release of explosive hydrocarbons by reducing the need to replace the valve.

The following terms are used herein:

The term “electrical actuator” refers to a device that has an electric motor which may be attached to the force transmitting member for rotation thereof without disturbing any components of the valve apparatus other than the elongated handle.

The term “hydraulic actuator” refers a fluid operated motor which may be attached to the force transmitting member for rotation thereof without disturbing any other components of the valve apparatus other than the elongated handle.

The term “inlet fluid” refers to liquid, liquid and gas, or a combination of liquid, gas, and particulate, wherein the particulate has a diameter from 1 to 2400 microns, and gas and particulate wherein the particulate has a diameter from 1 to 2400 microns, such as sand, ceramic, stones, and walnut shells.

The term “operating device” refers to at least one: pneumatic actuation, hydraulic actuation, electrically powered actuation, or mechanical actuation of the rotating driver apparatus. A valve apparatus for controlling the flow and pressure of fluids from a source of pressurized fluid with: a valve body, a valve chamber, a seat assembly in the valve chamber; a control member in the valve chamber axially movable with respect to the seat assembly, a lower stem connected to an output of an actuator of the valve, a valve bonnet attached to the valve body; the valve bonnet having a valve bonnet through bore with the lower stem slidingly reciprocating, moving the control member between the closed and open position, an annular sealing assembly, an outer seat carrier engaged within the valve body; the outer seat carrier comprising two elongated longitudinally disposed radial slots each oriented at right angles to the inlet port to impact a diversion wall of the outer seat carrier, splitting the inlet fluid into two flows simultaneously, reducing erosion on the radial slots.

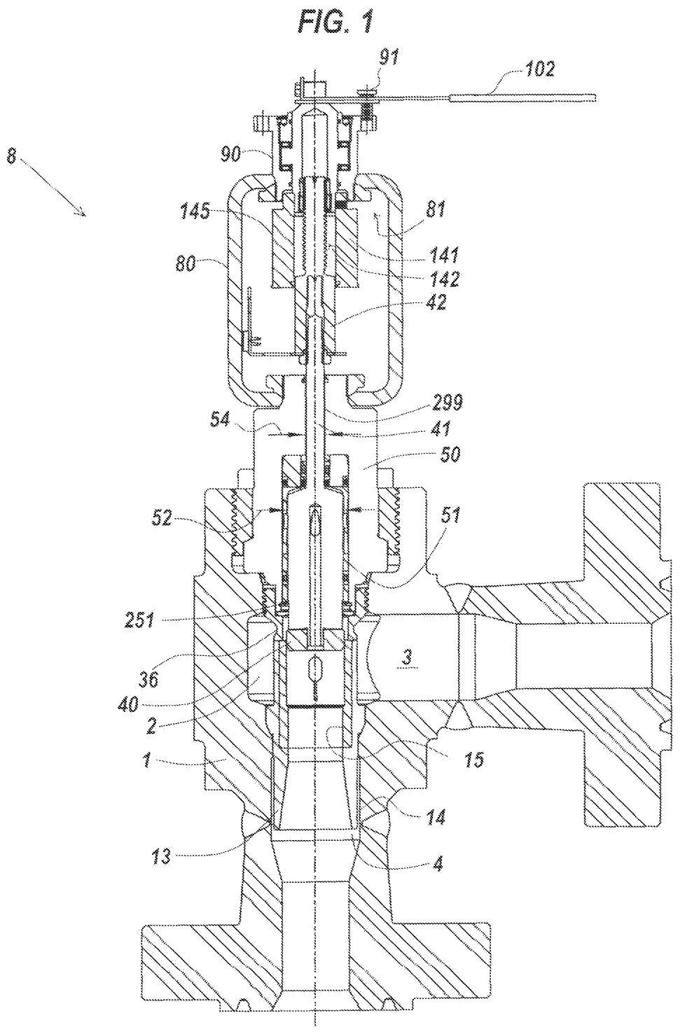

Turning now to the Figures, FIG. 1 depicts a section view of the valve apparatus for controlling the flow and pressure of fluids from a source of pressurized fluid.

The valve apparatus can control fluid flow ranging from “off” or no flow to fluid flow of 100 gallons per minute of a liquid while carrying a concentration of particulate ranging from 0.1 wt % based on the total amount of fluid to 10 wt % particulate. Particulate can be sand in an embodiment.

The valve apparatus gas flow (which is a fluid) can range from off or no flow to 40 million cubic feet per day. In embodiments, the gas is natural gas. The valve apparatus operates even while carrying a concentration of particulate in the gas ranging from 0.1 wt % based on the total amount of the gas to 10 wt % particulate.

The valve apparatus 8 for controlling the flow and pressure of fluids from a source of pressurized fluid has a valve body 1. The valve body can range from 9 inches to 50 inches in longitudinal length. The valve body can have a variety of geometric shapes, such as cylindrical or rectangular. The valve body can be steel, but not made from tool steel.

The valve body has a valve chamber 2 with an inlet port 3 and an outlet port 4.

The valve chamber can be single walled. The valve chamber can have a volume ranging from 6 cubic inches to 50 cubic inches.

The valve chamber 2 contains a seat assembly 13. The seat assembly can be centrally located in the valve chamber, extending downwardly toward the outlet. The seat assembly can be a metal, a mixture of carbide and metal, or carbide. The seat assembly has a diameter which is 20% to 50% smaller than the diameter of the valve chamber.

In embodiments, a control member 40 which in FIG. 1 is depicted as a plug, can be mounted in the valve chamber 2.

The control member 40 is axially movable with respect to the seat assembly 13 from a closed position preventing flow of fluids between the inlet port 3 and the outlet port 4 and selected open positions which provide fluid flow to predetermined flow areas.

The control member 40 regulates fluid flow and pressure by throttling fluids from the inlet port 3 to the outlet port 4.

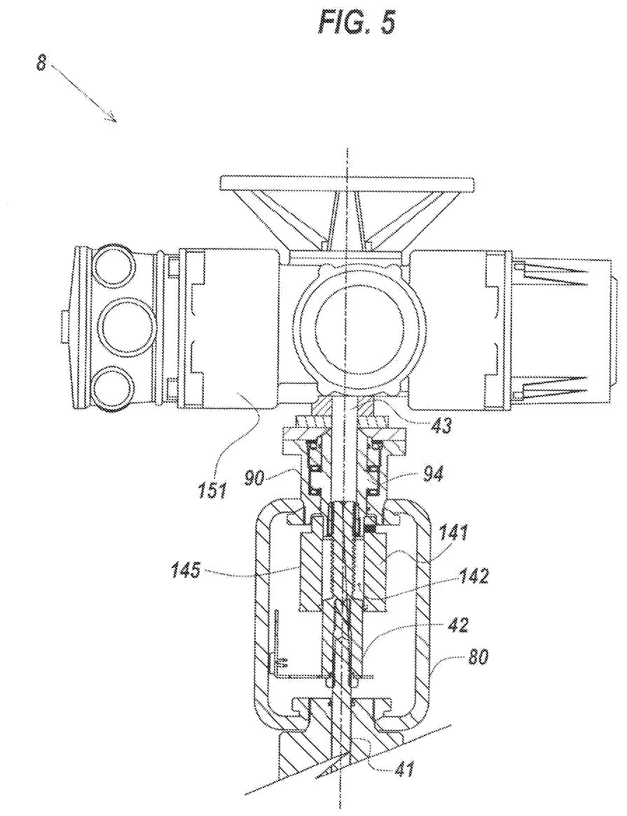

A lower stem 41 is connected to an output 43 of an actuator 151 of the valve apparatus 8. The output 43 and actuator 151 are shown in FIG. 5. The lower stem 41 can have a length from 12 inches to 24 inches with a diameter from 0.75 inches to 3 inches.

Returning to FIG. 1, a valve bonnet 50 is depicted attached to the valve body 1.

The valve bonnet 50 has a valve bonnet through bore 299 through which the lower stem 41 slidingly reciprocates while simultaneously moving the control member 40 between the closed position and a selected open fluid flow position.

The valve bonnet can be made from steel or stainless steel.

The valve bonnet can have an inner diameter slightly larger than the diameter of the lower stem.

An exemplary overall diameter of the valve bonnet can range from 3 inches to 6.5 inches. An exemplary overall length for the valve bonnet can range from 6 inches to 11 inches.

An annular sealing assembly 51 can secure to the valve bonnet 50. The annular sealing assembly is held in place to the valve bonnet with a retainer ring 251.

The annular sealing assembly can be made from elastomer, thermoplastic, and steel.

The steel supports the thermoplastic or elastomer element forming the seal. In embodiments, the thermoplastic or elastomer element can range from 3/16th inches in cross section to 5/16th inches in cross section.

The seal element and the support element are stacked together in the annular sealing assembly.

The annular sealing assembly 51 can surround the lower stem 41 in sliding and sealing engagement therewith.

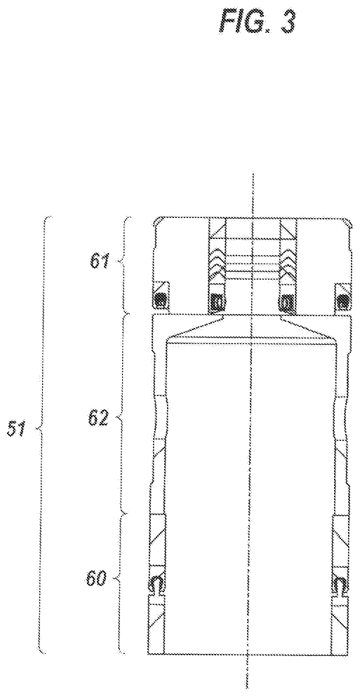

A detail of the annular sealing assembly can be seen in FIG. 3 that shows the annular sealing assembly 51 having an upper seal assembly 61 which can be an assembly of a seal cartridge of elastomer or thermoplastic and a steel support a lower seal assembly 60 having the same construction as the upper seal assembly and a spacer 62 that can be made from steel, here between. The unique annular seal assembly provides increased safety and reduction in potential leaks for the valve apparatus.

Returning to FIG. 1, the lower stem 41 is formed with a lower large diameter portion 52 and an upper smaller diameter portion 54. In embodiments, the upper smaller diameter portion 54 is 0.5 inches to 0.75 inches smaller than the lower large diameter portion 52.

FIG. 1 shows a yoke 80 attached to the valve bonnet 50. The yoke can be made from steel. The yoke is above the valve bonnet and at least 10% to 30% larger than the valve bonnet.

The yoke can be any shape, such as rectangular, which allows for the fixed positioning of the rotating driver assembly 90 and the valve bonnet 50 while allowing visual access to indices 145 and allowing the anti-rotation assembly 240 a feature to press against.

The yoke can have a height of 8 inches to 18 inches, a width of 4 inches to 6 inches, and a length of 4 inches to 6 inches, and all the numbers in between.

The yoke 80 has an opening 81 on at least one side thereof for physical and visual access to an upper stem 42 and a cylindrical drum 141 having indicia 145 on an outer surface.

The indicia 145 are helically disposed around the cylindrical drum 141 for precisely indicating the position of the control member 40 simultaneously with the predetermined fluid flow areas.

FIG. 1 shows a rotating driver assembly 90 which is secured to an actuator 151 of the valve that is shown in FIG. 5. The rotating driver assembly 90 is supported from a yoke 80 with, for example, a fastener, such as a retaining nut.

The rotating driver assembly 90 translates rotational movement to axial movement of the lower stem 41 and translates rotational movement to axial movement to the control member 40 and to an operating device 102, which is depicted as a handle in FIG. 1.

The rotating driver assembly 90 can be cylindrical in shape, and have an overall diameter of 5 inches to 7 inches.

In embodiments, a rotating driver assembly 90 can be secured to the yoke 80 by a large retainer nut threadedly engageable to the upper stem 42 which is also connected to the lower stem.

The operating means 102 can include a removable elongated handle which may be manually moved to apply the operating force to the rotating driver assembly 90, the operating means having a lock 91, locking the upper stem and the control means in a closed or in a selected open position.

In FIG. 1, the lower stem 41 is shown secured to one end of an upper stem 42 providing axial movement for the control member 40.

FIG. 1 shows the through bore 299 as stepped, with at least two different diameters, and a retainer ring 251 holding the annular sealing assembly 51 within the valve bonnet 50.

FIG. 1 depicts a seat retainer 36 which threadably engages the valve body 1 above the valve chamber 2.

In embodiments, the seat retainer 36 engages the valve bonnet 50, preventing rotation of the seat retainer 36 unless the valve bonnet is removed.

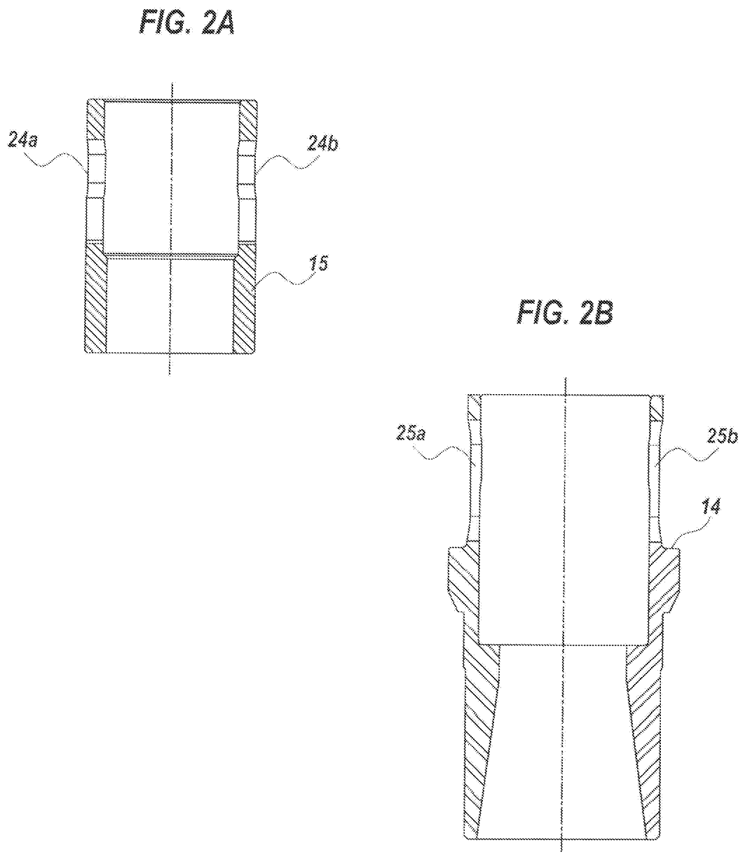

The outer seat carrier 14 has two elongated longitudinally disposed radial slots 25a and 25b, shown in FIGS. 2A and 2B.

The outer seat carrier 14 has an inner seat insert 15.

The outer seat carrier and the inner seat insert can be made from tool steel having a hardness from 22 to 60 Rockwell™ C hardness.

In embodiments, the valve apparatus has a cylindrical drum 141 with a cylindrical cavity 142 that has a slightly larger diameter than the upper stem 42.

The upper stem 42 reciprocates within the cylindrical cavity 142.

FIGS. 2A and 2B show an outer seat carrier 14 that engages within the valve body 1.

The outer seat carrier 14 has two elongated longitudinally disposed radial slots 25a and 25b.

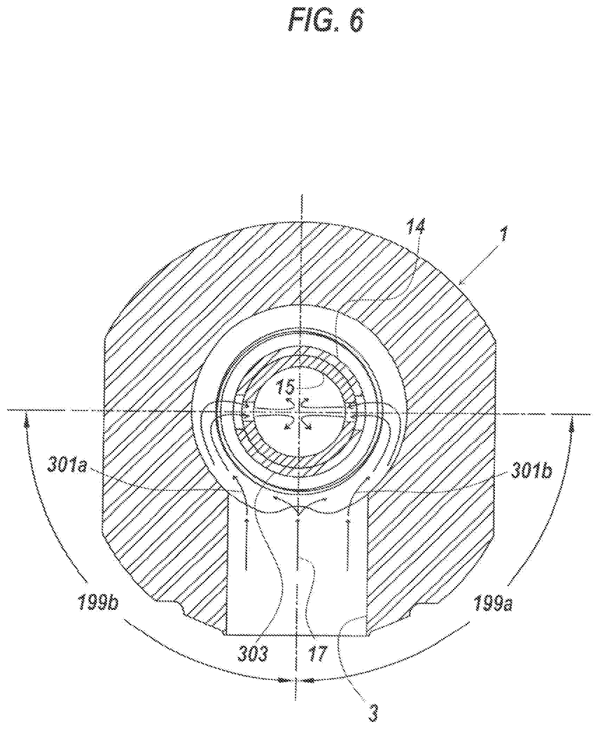

Each elongated longitudinally disposed radial slot is oriented at a 90 degree angle 199a and 199b (shown in FIG. 6) which can vary as much as ±20° respectively to the inlet port 3 (shown in FIG. 6 as well).

The inner seat insert 15 has two inner seat slots 24a and 24b.

FIG. 6 also shows the inner seat insert 15 is coaxially assembled into the outer seat carrier 14 enabling inlet fluid 17 to impact a diversion wall 303 of the outer seat carrier 14 splitting the inlet fluid 17 into two flows 301a and 301b and through the mated slots simultaneously, reducing erosion on the mated slots.

In embodiments the outer seat carrier 14 has a uniform thickness tubular material eliminating additional flow paths through the outer seat carrier.

In embodiments the outer seat carrier 14 can be made of: a steel, stainless steel, nickel alloy metal, a 100% carbide material, and a 100% ceramic material.

Turning now to FIG. 3 which depicts a section view of an annular sealing assembly.

The annular sealing assembly 51 has an upper seal assembly 61, a lower seal assembly 60 and spacer 62.

The spacer 62 provides an annular space surrounding the lower stem directly above the lower large diameter portion 52 of the lower stem.

The annular space is in fluid communication with the outlet port 4 through the control member 40 and through the lower stem 41 to pressure balance the lower stem 41 and the control member 40.

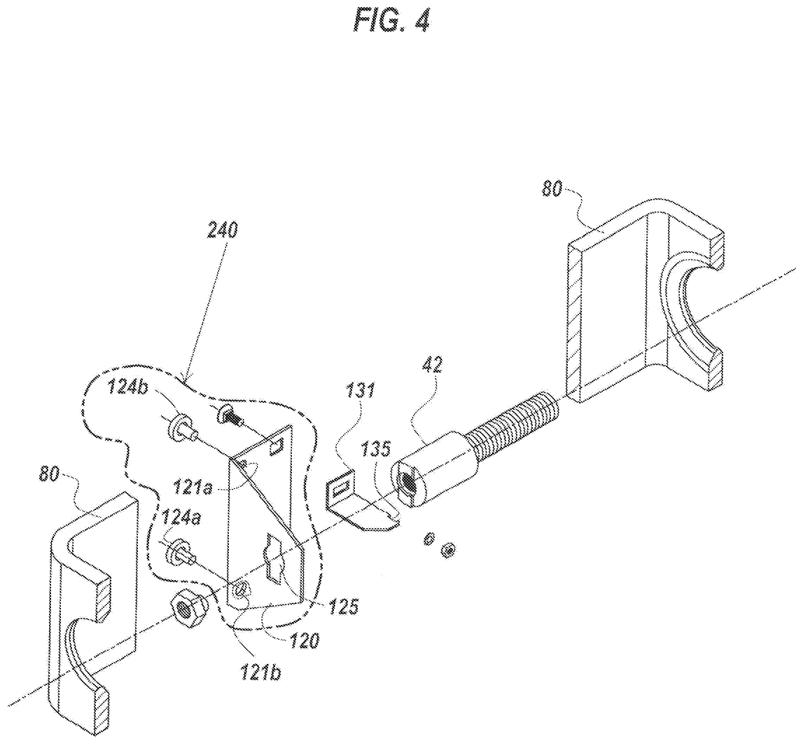

Turning now to FIG. 4. FIG. 4 depicts an embodiment of the anti-rotation assembly.

In embodiments an anti-rotation assembly 240 can be connected to the upper stem 42 and the lower stem 41. The anti-rotation assembly prevents rotation of the upper stem 42 as seen in FIG. 1.

In embodiments, the anti-rotation assembly 240 can include an angular plate 120, a slotted hole 125, a pair of tabs 124a and 124b engaging the angular plate 120 through a pair of connecting holes 121a and 121b respectively.

The anti-rotation device engages an adjustable indicator pointer 131 and an indicator slot 135 supporting the indicator pointer 131.

The anti-rotation assembly 240 and the adjustable indicator pointer are within the yoke 80.

FIG. 5 depicts a detail of the valve apparatus 8 as connected to an actuator 151.

The output 43 of the actuator 151 is connected to a stem driver 94 of the rotating driver assembly 90.

Indicia 145 is shown on an outer surface of cylindrical drum 141.

It should be noted that the cylindrical drum 141 is attached to stem driver 94.

The cylindrical drum 141 is shown with a cylindrical cavity 142 having a slightly larger diameter than a diameter of the upper stem 42, enabling the upper stem 42 to reciprocate within the cylindrical cavity 142.

Lower stem 41 is shown.

The yoke 80 is also labelled.

FIG. 6 depicts a fluid flow path created by the outer seat carrier 14 in the valve body 1.

The outer seat carrier 14 is engaging the inner seat insert 15, and the two are mating together within the valve body.

The outer seat carrier 14 has two elongated longitudinally disposed radial slots, each of which is oriented at a 90 degree angle 199a and 199b to the inlet port 3 enabling inlet fluid 17 to impact a diversion wall 303 of the outer seat carrier 14 splitting the inlet fluid 17 into two fluid flows 301a and 301b simultaneously reducing erosion on the radial slots.

### Example

A valve apparatus for controlling the flow of fluids from a source of pressurized fluid, the apparatus can include a valve body that is made from steel with an overall length of 18 inches.

The valve body having a valve chamber that provides an inner diameter of 4.68 inches.

The valve body has an inlet port with a diameter of 3.06 inch and an outlet port with the same diameter.

The valve body has a seat assembly made of stainless steel that is inserted in the valve chamber. The seat assembly has an outer dimension that is 2.87 inches.

A control member that is a plug made out of carbide is inserted in the seat assembly of the valve chamber.

The plug can be moved approximately 1.818 inches axially in the valve chamber forming a closed position against the seat assembly preventing flow of fluids between the inlet port and the outlet port.

The plug can be positioned at selected open positions, such as 0.9 inches, 0.8 inches or 1.1 inches which provides predetermined flow areas through which fluid flow and pressure throttling of fluids from the inlet port to the outlet port occurs.

A lower stem which is attached to plug is also connected to an output of an actuator of the valve.

The actuator can be an electrical actuator with an electric motor. The voltage of the actuator is typically 24 Volts DC. However, the voltage may be any of many possible voltages such as 12, 110, 200, or 220 Volts DC.

A valve bonnet that is 4.25 inches outer diameter with a length of 8.19 inches made from stainless steel is attached to the valve body.

The valve bonnet has a through bore with an inner diameter of 0.66 inches through which the lower stem having an outer diameter of 0.632 inches slidingly reciprocates while moving the control member between the flow preventing position and a selected open position.

An annular sealing assembly made of thermoplastic and stainless steel secures to the valve bonnet through an additional bore.

The annular sealing assembly surrounds the lower stem in sliding and sealing engagement therewith.

The lower stem has a lower large outer diameter portion of 1.9 and an upper smaller diameter portion of 0.632.

The annular sealing assembly has an upper seal assembly, a lower seal assembly and spacer there between. The spacer can be made from stainless steel.

In embodiments, an outer seat carrier can be made from steel to engage within the valve body.

In embodiments the outer seat carrier has two elongated longitudinally disposed slots.

In embodiments, each slot of the outer seat carrier can have an opening with a length of 1.54 inches.

In embodiments each slot of the outer seat carrier as mated with the inner seat slots, is oriented at a 90 degree angle to the inlet port enabling inlet fluid made of 90% natural gas and 10% particulate to impact the diversion wall of the seat carrier that is made from steel and in an example, is 2.19 inches tall and 0.179 inches thick splitting the inlet fluid into two fluid flows simultaneously.

In embodiments the particulate of the fluid flow can have a size from 100 microns in diameter to 2400 microns in diameter, and all the numbers in between, and can be composed of sand, rock, pecan shells, or ceramic pellets.

The slot orientation simultaneously reducing erosion by 50% on the radial slots compared to slots oriented at other angles to the fluid flow.

While a single embodiment and alternate operation thereof have been disclosed herein, many variations of the disclosed apparatus may be made without departing from the spirit of the disclosed apparatus. Accordingly, the scope of the disclosed apparatus is to be limited only by the claims which follow.

While these embodiments have been described with emphasis on the embodiments, it should be understood that within the scope of the appended claims, the embodiments might be practiced other than as specifically described herein.

What is claimed is:

1. A valve apparatus for controlling the flow of fluids from a source of pressurized fluid, the apparatus comprising:
a. a valve body having a valve chamber with an inlet port and an outlet port;
b. a seat assembly mounted in the valve chamber;
c. a control member mounted in the valve chamber and axially movable with respect to the seat assembly from a closed position preventing flow of fluids between the inlet port and the outlet port and selected open positions which provide predetermined flow areas through which flow and pressure throttling of fluids from the inlet port to the outlet port occurs;
d. a lower stem connected to the control member;
e. a valve bonnet attached to the valve body, the valve bonnet having a valve bonnet through bore through which the lower stem slidingly reciprocates while moving the control member between the closed position and a selected open position;
f. an annular sealing assembly secured to the valve bonnet, the annular sealing assembly surrounds the lower stem in a sliding and sealing engagement therewith, the lower stem having a lower large diameter portion and an upper smaller diameter portion, the annular sealing assembly having an upper seal assembly, a lower seal assembly and a spacer there between; and
g. an outer seat carrier engaged within the valve body, the outer seat carrier comprising two elongated longitudinally disposed radial slots, each radial slot oriented at a 90 degree angle respectively to the inlet port, the outer seat carrier having an inner seat insert, the inner seat insert comprising two inner seat slots, wherein the inner seat insert is coaxially assembled into the outer seat carrier enabling inlet fluid to impact a diversion wall of the outer seat carrier splitting the inlet fluid into two flows and through the mated slots simultaneously, reducing erosion on the mated slots.

2. The valve apparatus of claim 1, wherein the inner seat insert, comprises at least one of: a carbide, a stellite, a ceramic, a diamond, or an alloy of steel.

3. The valve apparatus of claim 1, comprising an anti-rotation assembly connected to an upper stem and the lower stem, the anti-rotation assembly preventing rotation of the upper stem.

4. The valve apparatus of claim 3, wherein the anti-rotation assembly comprises: an angular plate, a slotted hole, a pair of tabs engaging the angular plate through a connecting hole respectively, the anti-rotation device connected to an adjustable indicator pointer, and an indicator slot supporting the indicator pointer.

5. The valve apparatus of claim 1, comprising a rotating driver assembly secured to the actuator of the valve supported from a yoke the rotating driver assembly translating rotational movement to axial movement of the lower stem and to the control member; and an operating device.

6. The valve apparatus of claim 5, comprising a cylindrical drum attached to the rotating driver assembly, the cylindrical drum having a cylindrical cavity having a slightly larger diameter than a diameter of the upper stem, wherein the upper stem reciprocates within the cylindrical cavity.

7. The valve apparatus of claim 1, wherein the spacer provides an annular space surrounding the lower stem directly above the lower large diameter portion of the lower stem, the annular space being in fluid communication with the outlet port through the control member and through the lower stem to pressure balance the lower stem and the control member.

8. The valve apparatus of claim 1, wherein the through bore is stepped, has at least two different diameters, and a retainer ring holding the annular sealing assembly within the valve bonnet.

9. The valve apparatus of claim 6, wherein the yoke comprises an opening on at least one side thereof for physical and visual access to the upper stem, the cylindrical drum having indicia on an outer surface which are helically disposed there around the cylindrical drum for precisely indicating the position of the control member and the predetermined fluid flow areas.

10. The valve apparatus of claim 5, wherein the operating means comprises a removable elongated handle, which may be manually moved to apply operating force to the rotating driver assembly, the operating means having a lock locking the upper stem and the control means in a closed or in a selected open position.

11. The valve apparatus of claim 1, comprising a seat retainer which threadably engages the valve body above the valve chamber.

12. The valve apparatus of claim 11, wherein the seat retainer engages the valve bonnet, preventing rotation of the seat retainer unless the valve bonnet is removed.

13. The valve apparatus of claim 1, wherein the outer seat carrier comprises at least one of: a steel, stainless steel, nickel alloy metal, a 100% carbide material, and a 100% ceramic material.
